(19) United States
(12) Patent Application Publication
(10) Pub. No.: US 2009/0311534 A1
(43) Pub. Date: Dec. 17, 2009

(54) METHODS AND SYSTEMS FOR IMPROVING AN ORGANIC FINISH ADHESION TO ALUMINUM COMPONENTS

(76) Inventors: Bruce M. Griffin, St. Louis, MO (US); Lawrence M. Lawless, Chesterfield, MO (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 12/137,948

(22) Filed: Jun. 12, 2008

(51) Int. Cl. C23C 22/56; C23C 22/78; C23G 1/00; B32B 33/00; C23C 22/24

(52) U.S. Cl. 428/409; 148/243

(57) ABSTRACT

A surface treatment method for aluminum parts to improve adhesion of organic finishes to be applied to the aluminum parts is described. The method includes cleaning the aluminum part, deoxidizing the aluminum part, applying a conversion coating to the part, and rinsing the part in hot de-ionized water.

### BACKGROUND OF THE INVENTION

The field of the invention relates generally to paint adhesion, and more specifically, to methods and systems for improving an organic finish adhesion to aluminum components.

Painted aluminum parts are often utilized on aircraft and other motorized vehicles. However, these painted aluminum parts are often subject to paint adhesion failures. At least part of the reason for such paint adhesion failures may be due to the surface treatment processes that are commonly used in preparation of the aluminum for the primer and paint application cycles, or organic finishes.

Anodizing is one process that is utilized to provide a more suitable surface preparation for paint application and paint adhesion. However, converting processes to incorporate an anodizing step for a number of detail parts in an assembly increases expense, as anodizing is a relatively expensive surface treatment process. However, and as stated above, anodizing, when properly sealed or in an unsealed condition, is believed to provide a surface condition that is well suited for good adhesion of an organic finish system (e.g., primer and topcoat paints).

Anodizing is not without its drawbacks. First, anodizing is a more expensive process than other known surface preparation techniques, and anodizing generates a greater volume of hazardous waste and consumes greater amounts of energy than the other known surface preparation techniques. In addition, anodizing has a deleterious affect on the fatigue life of the basis metal.

In the manufacturing environment, a separate issue to be considered is the amount of time required to change documentation of processes. Documentation changes are an expense, and such expenses can be significant, when changes to processes are to be implemented. Generally, for an entity to undergo the expense of process change documentation, there needs to be a significant reduction in manufacturing costs and/or more than an incremental change in the quality of the manufactured product.

### BRIEF DESCRIPTION OF THE INVENTION

In one aspect, a surface treatment method for aluminum parts to improve adhesion of organic finishes to be applied to the aluminum parts is provided. The method includes cleaning the aluminum part, deoxidizing the aluminum part, applying a conversion coating to the part, and rinsing the part in hot de-ionized water.

In another aspect, an aluminum component having a surface, the surface treated to improve adhesion of organic finishes to be applied to said aluminum component is provided. The surface is treated with a cleaning process, a deoxidizing process, a low chrome conversion coating process, and a hot de-ionized water rinsing process.

### BRIEF DESCRIPTION OF THE DRAWINGS

FIG. 1 is a flowchart that illustrates a surface treatment process for aluminum.

### DETAILED DESCRIPTION OF THE INVENTION

Beginning with the introduction of high solid content and water reducible coatings, (i.e., primer coatings and topcoats), reliable adhesion of organic coating to an aluminum substrate has been difficult to attain, even though surface treatment methods, such as conversion coating and anodizing processes did not change. Generally, coatings such as primer and paint are applied to metal to delay corrosion. A complete coating system consists of one or more surface treatments, for example, a conversion coating process or an anodizing process to prepare the surface of the metal for the application of primer and paint. The surface preparation processes are then followed by one or more primer coatings and in some cases a top coat of paint is also applied.

Herein described are processes for the surface treatment of aluminum that provides for corrosion protection, while also providing an excellent foundation for organic finishes such as primers and topcoat paints.

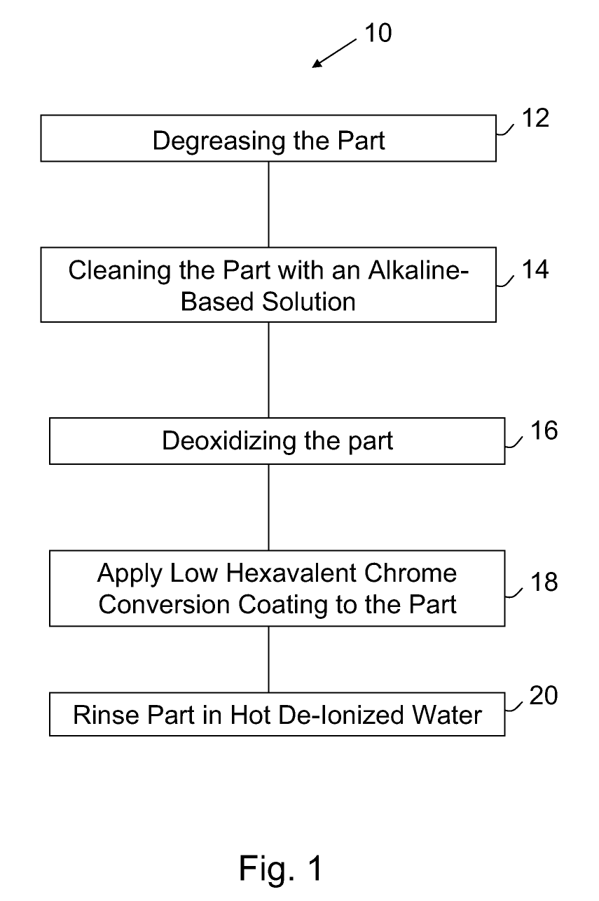

The described surface treatment method minimizes, or eliminates use of hexavalent chrome, depending on the conversion coating selected, while still improving the adhesion of organic finish systems as compared to anodizing and other surface preparation processes. As a result, the corrosion protection afforded via the surface treatment process is superior to systems or treatments that rely on the corrosion protection ability of various individual surface treatment materials. FIG. 1 is a flowchart 10 that illustrates the surface treatment process for aluminum mentioned above. Specifically, the part is cleaned, which may include both a degreasing 12 step and a separate cleaning 14 step. In one embodiment, the cleaning 14 step is an alkaline-based cleaning step. The part is then deoxidized 16, which may include a combination of one or more of aluminum desmutting, pickling and deoxidizing, depending upon inspection and organic finish requirements. In alternative embodiments, pickling includes acid pickling or alkaline pickling. Desmutting refers to a process of removing a loosely adherent film or smut on the surface being prepared, which negatively impacts adhesion of subsequent plating to the aluminum. This film smut generally includes impurities or alloy constituents in the aluminum, and generally contains metallic constituents. After the deoxidizing step, a conversion coating, such as colorless conversion coating, which has a low concentration of hexavalent chrome, (1-10% chromic acid), multicolor conversion coating, which has a higher concentration of hexavalent chrome, (30-60% chromic acid), or a trivalent conversion coating, which has no hexavalent chrome, is applied 18 to the part. The part is then rinsed 20 in hot, de-ionized water. The temperature range for the hot water is from about 120 degrees Fahrenheit to about 160 degrees Fahrenheit. In one particular embodiment, the de-ionized water is heated to approximately 140 degrees Fahrenheit.

The use of a low hexavalent, or trivalent chrome conversion coating when combined with a post-conversion coat rinse in hot, de-ionized water provides a superior surface and foundation for the eventual application of organic finishes. Low hexavalent chrome, or trivalent chrome conversion coating by itself generally offers little to no corrosion protection for exposed aluminum. However, with the improved adhesion of organic finishes offsets the lack of corrosion protection provided by the low hexavalent or trivalent chrome conversion coating. Therefore, the overall corrosion protection offered through practice of the method of FIG. 1 and subsequent application of organic finishes is superior to that provided by high chrome conversion coated surfaces, and comparable to that provided through anodized surfaces.

Existing aluminum surface preparation solutions include chromated conversion coating surface treatment, or an anodizing process with a chromate seal process. Both of these existing solutions generate a greater volume of hazardous waste as neither presently uses a combination of one or more of desmutting, pickling and deoxidizing solutions. Anodizing processes utilize a far greater amount of energy. However, of the two, only a properly anodized seal offers a comparable organic finish adhesion, as the process illustrated by FIG. 1, but at a much greater cost. To summarize, the method proposed in FIG. 1 reduces use of hexavalent chrome, decreases energy use, and provides superior adhesion of organic finishes to aluminum, all at a lower cost.

Aluminum treated with a low hexavalent or trivalent chrome conversion coating, followed by a hot rinse, exhibits coating (e.g., paint) adhesion equivalent to properly sealed anodize when measured by a reverse impact test. The process cycle time for application of the low chrome coating is about three minutes versus an average of 25 minutes for anodize. The difference is an 88% reduction in processing time to achieve the same coating adhesion.

Process development work has demonstrated that corrosion resistance imparted on the basis metal by conversion coating can be improved by minimizing pickling and deoxidizing processes, which are common practice before application of conversion coating. Pickling, or etching is necessary when the basis metal exhibits a thick oxide scale, and to facilitate nondestructive test methods when required.

If the aluminum basis metal exhibits only a light or thin scale, such as oxides that develop from atmospheric exposure, treatment with the 75% nitric acid desmutting solution followed by a light or minimal exposure to the deoxidizing solution creates a metal surface condition ideal for conversion coating. If heavy scale exists on the basis metal due to heat treating or long term exposure to ambient atmospheric conditions, treatment with the 75% nitric acid desmutting solution will minimize surface oxides before pickling, hence exposure to the pickling solution is also minimized. Post-pickle treatment with 75% nitric acid desmutting solution removes compounds that form on the surface of the basis aluminum as a result of pickling, and use of the desmutting solution as a pretreatment for deoxidizing will greatly extend the service life of the more expensive deoxidizing solution.

Evaluation of the method described by FIG. 1 has been completed utilizing several different epoxy primer formulations. In one analysis, organic coating adhesion performance when using a low chrome colorless conversion coating, was compared to the adhesion performance of a multicolor, (high hexavalent chrome), conversion coating. The performance of the low chrome conversion coating was found to be superior. In another analysis, an indirect comparison between organic coating adhesion performance using a low chrome conversion coating and adhesion performance on a part that utilized the anodizing process was performed. The surface treatment methods were found to be equivalent in regard to adhesion of organic finishes. Performance of the low chrome conversion coating is currently being tested for corrosion resistance performance.

Each of the process elements for the low hexavalent chrome conversion coating method described by FIG. 1 are utilized throughout industry and are used by all original equipment manufacturers in some form. However, specific instructions regarding use of each of the process elements are dictated by the process specifications associated with these entities.

Since the materials associated with the described process are generally available, use of the low hexavalent or trivalent chrome conversion coating, instead of an anodizing solution, will reduce process cycling times by 88%. Reducing cycling times, improving coating adhesion, and eliminating re-work/repainting of detail parts in various states of assembly has the potential of saving thousands of labor hours. Improved end customer satisfaction is another likely result.

While the conversion coatings referred to herein have little or no hexavalent chrome, they do provide a foundation for primer adhesion that is comparable to chromic acid and thin-film sulfuric acid anodize. As mentioned above, a final hot rinse of this type of conversion coating is detrimental to corrosion resistance. However, the increase in primer adhesion results in a net gain in surface coating quality and longevity for the finished part.

Improved adhesion of organic finishes reduces coating adhesion failures at customer locations and reduces customer rework efforts. Improved adhesion performance of organic finishes also reduces corrosion, and overall maintenance costs are reduced. As explained above, low chrome conversion coating and hot water rinsing surface preparation process offers a definite advantage in the often difficult area of paint adhesion. The process also offers a benefit in being quicker, cheaper and lower in hazardous waste product use as compared to currently used alternative processes.

While the invention has been described in terms of various specific embodiments, those skilled in the art will recognize that the invention can be practiced with modification within the spirit and scope of the claims.

What is claimed is:

1. A surface treatment method for aluminum parts to improve adhesion of organic finishes to be applied to the aluminum parts, said method comprising:
cleaning the aluminum part;
deoxidizing the aluminum part;
applying a conversion coating to the part; and
rinsing the part in hot de-ionized water.

2. A method according to claim 1 wherein rinsing the part comprises rinsing the part in de-ionized water that has been heated to a temperature ranging from about 120 degrees Fahrenheit to about 160 degrees Fahrenheit.

3. A method according to claim 1 wherein rinsing the part comprises rinsing the part in de-ionized water that has been heated to a temperature of approximately 140 degrees Fahrenheit.

4. A method according to claim 1 wherein applying a conversion coating comprises applying a low chrome conversion coating to the part.

5. A method according to claim 4 wherein applying a low chrome conversion coating to the part comprises applying a colorless conversion coating that is low in hexavalent chrome to the part.

6. A method according to claim 4 wherein applying a low chrome conversion coating to the part comprises applying a trivalent conversion coating that has no hexavalent chrome to the part.

7. A method according to claim 1 wherein cleaning the part comprises:
subjecting the part to a degreasing process; and
subjecting the part to a cleaning process.

8. A method according to claim 7 wherein subjecting the part to a cleaning process comprises subjecting the part to an alkaline-based cleaning process.

9. A method according to claim 1 wherein deoxidizing the part comprises at least one of:
desmutting the part; and
deoxidizing the part.

10. A method according to claim 9 wherein desmutting the part further comprises pickling the part when the part exhibits an oxide scale.

11. A method according to claim 10 wherein pickling the part comprises:
pickling the part using a nitric acid-based desmutting solution; and
exposing the part to a deoxidizing solution.

12. A method according to claim 11 wherein pickling the part using a nitric acid-based desmutting solution comprises pickling the part using 75% nitric acid-based desmutting solution.

13. A method according to claim 9 wherein desmutting the part comprises desmutting the part using a nitric acid-based desmutting solution.

14. An aluminum component having a surface, the surface treated to improve adhesion of organic finishes to be applied to said aluminum component, the surface treated with:
a cleaning process;
a deoxidizing process;
a low chrome conversion coating process; and
a hot de-ionized water rinsing process.

15. An aluminum component according to claim 14 wherein said hot de-ionized water rinsing process comprises a rinsing process in de-ionized water that has been heated to a temperature ranging from about 120 degrees Fahrenheit to about 160 degrees Fahrenheit.

16. An aluminum component according to claim 14 wherein said hot de-ionized water rinsing process comprises a rinsing process in de-ionized water that has been heated to a temperature of approximately 140 degrees Fahrenheit.

17. An aluminum component according to claim 14 wherein said low chrome conversion coating process comprises application of a colorless conversion coating that is low in hexavalent chrome to the part.

18. An aluminum component according to claim 14 wherein said low chrome conversion coating process comprises application of a trivalent conversion coating that has no hexavalent chrome to the part.
